(19) United States
(12) Patent Application Publication
(10) Pub. No.: US 2010/0058286 A1
(43) Pub. Date: Mar. 4, 2010

(54) SYSTEM AND A METHOD FOR RENDERING COMPUTER-BASED INTERACTIONS AS GROUP ACTIVITIES

(76) Inventor: Vikas Vasudeo Joshi, (US)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/547,660

(22) Filed: Aug. 26, 2009

Related U.S. Application Data
(60) Provisional application No. 61/103,585, filed on Oct. 8, 2008.

(30) Foreign Application Priority Data
Aug. 27, 2008 (IN) 1801/MUM/2008

(51) Int. Cl. G06F 9/44; G06F 17/30

(52) U.S. Cl. 717/104; 707/100; 707/200

(57) ABSTRACT

Disclosed herein is a system and a method for creating and facilitating computer-based interactions amongst a group of individuals during a group activity. In an embodiment herein, an activity player is provided for rendering instances of the group activity. A library of activity templates is also provided so that instances of said activity templates may be used to create an activity executable. An activity data file may be created for storing data corresponding to the instances of activity templates used in the activity executable, wherein said activity executable and activity data file are used to create the group activity. Said group activity may be then rendered by the activity player.

### FIELD OF INVENTION

The embodiments herein relate to facilitation of computer-based interactions during group activities being performed by a group of individuals.

### BACKGROUND OF THE INVENTION

In the present era, computer-based technology has become very helpful to humans. In various fields computer-based applications have benefited individuals in their works. For example, an educator, instructor or presenter is able to easily interact with his/her students/trainees/audiences with the help of computer-based applications such as software for displaying presentations, graphics and multimedia.

However, mere computer-based presentations can become monotonous for students or audiences if the instructor or presenter does not provide some means of manual interactions through various activities such as polling, games etcetera. Providing means of manual interactions may completely depend on individual's skill and knowledge and all individuals may not be able to make their sessions interesting to the audiences.

Therefore there is required a novel solution for interactive computer-based presentations.

### SUMMARY OF THE INVENTION

An object of the present invention is to render computer-based interactions as group activities amongst a group of individuals.

Another object of the present invention is to enable a presentation creator to create computer based interactions for interactive presentations.

Another object of the present invention is to enable a presenter for presenting interactive computer-based presentations.

In accordance with this, there are provided a system and a method for creating and facilitating computer-based interactions wherein an activity player is provided for rendering instances of the group activity. A library of activity templates may be created, the instances of which may be used to create an activity executable. The activity executable may be created by using instances of said activity templates in computer-based interaction code.

Further, an activity data file may be created for storing data corresponding to the instances of activity templates used in the activity executable. Thereafter, said activity executable and activity data file may be used to create the group activity to be rendered by the activity player.

In one embodiment herein, an activity manager may be provided for creating and/or modifying group activity instances by editing activity data file.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates functional components of the system as per an embodiment herein.

FIG. 2 is a flow chart illustrating the process of creating a group activity as per an embodiment herein.

FIG. 3 is a flow chart illustrating the process of creating and managing a group activity instance as per an embodiment herein.

FIG. 4 is a flow chart illustrating the process of rendering a group activity instance as per an embodiment herein.

### DETAILED DESCRIPTION OF PREFERRED EMBODIMENT

Disclosed herein are a system and a method for creating and facilitating computer-based interactions amongst a group of individuals during a group activity. Users or individuals are allowed to easily embed group activities to their computer-based presentations.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems.

Reference in the specification to “one embodiment” or “an embodiment” means that a particular feature, characteristic, or function described in connection with the embodiment is included in at least one embodiment of the invention. The appearances of the phrase “in one embodiment” in various places in the specification are not necessarily all referring to the same embodiment.

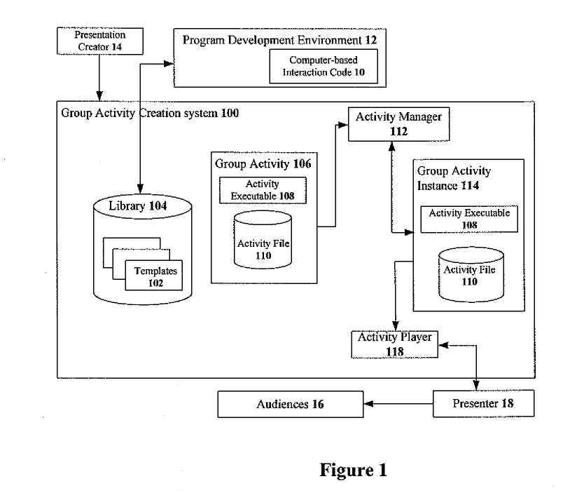

FIG. 1 is the block diagram of the group activity creation system 100 herein after refer to as ‘system’ 100, capable of creating and facilitating computer-based interactions as group activities as per an embodiment herein. FIG. 1 also illustrates use of the system 100 by a presentation creator 14 in order to create interactive presentations that may further be used by a presenter 18 for delivering the same to his/her audiences 16 in more interactive manner as per an embodiment herein.

In one embodiment herein, the system 100 comprises a library 104 of activity templates 102, an activity executable 108, an activity data file 110, a group activity 106 that consists of activity executable 108 and activity data file 110, an activity manager 112, and an activity player 118.

As per an embodiment herein the library 104 is a group activity element templates library 104 that includes a set of pre-created group activity element templates 102. Individuals or users or presentation creators 14 are allowed to use their choice of templates 102 to create various group activities 106 and subsequently interact with the audiences 16 in a more interactive manner.

The activity executable 108 is a computer-based group activity executable 108 and the activity data file 110 is a group activity data file 110. The computer based group activity executable 108 is created by a program development environment 12 from computer-based interaction code 10, by using instances of group activity element templates 102 and group activity data file 110.

The activity manager 112 is a group activity instance manager 112 that creates a group activity instance 114 by editing group activity data file 110. It is also capable of and modifying a group activity instance 114 by editing its group activity instance data file 116.

The activity data file 110 stores data corresponding to the instances of activity templates 102 used in the activity executable 108 wherein said activity executable 108 and activity data file 110 are used to create the group activity 106 to be rendered by the activity player 118. The activity player or group activity player 118 renders the group activity instance 114 which is seen by groups of attendees 120 or audiences 16. The audiences 16 give their inputs which the presenter 18 inputs into the group activity 106 using the interface provided by the activity player. These inputs for instance may include votes for the polls, answers to the questions or options for the games.

Users (as presentation creators 14) are allowed to simply select and add a group activity to his/her presentation slide. A user as a presentation creator 14 is allowed to select a pre-built group activity template 102 (For example: a Flash template), where the user (presentation creator 14) may enter contents specific to his/her topic, and save it. The saved group activity 106 is embedded as part of the presentation slides and thus the user/speaker/presenter 18 easily delivers a more interactive session to the audiences 16.

A preferred method of creating a group activity 106 will be now described. This method may be used by a user as a presentation creator 14 who wants to create a group activity 106. In various embodiments of the invention, the group activity may include but not limited to group polling, group quiz, group games etcetera.

In one embodiment herein the system 100 may be used by a presentation creator 14 in order to create and facilitate interactive presentation for his/her audiences 16. The presentation creator 14 uses the group activity creation system 100 and creates a presentation with group activities 106.

The presenter 18 presents the presentation to audiences 16. The audiences 16 give their inputs and the presenter 18 enters the inputs given by audiences 16 into the presentation.

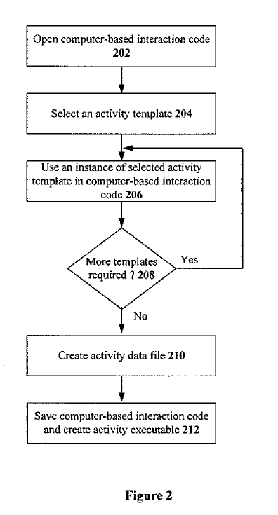

FIG. 2 is a flow chart illustrating the process of creating a group activity.

In step 202, open computer-based interaction code in program development environment.

In step 204, select a group activity element template from the library of group activity element templates.

In step 206, use an instance of the selected group activity element template in computer-based interaction code.

In step 208, decide if more such group activity elements are required. If yes, go back to step 206, else go ahead to step 210.

In step 210, create a group activity data file.

In step 212, save the computer-based interaction code and create computer-based group activity executable.

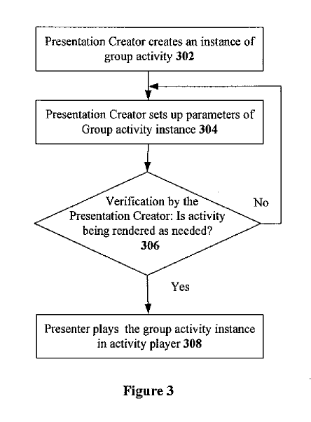

A preferred method of creating and managing group activity instance 114 will now be described with the help of flowchart in FIG. 3. This method may be used by a user (as the ‘presentation creator’ who wants to create an interactive presentation with group activities and the ‘presenter’ who wants to present the interactive presentation to audiences).

Starting with step 302, the presentation creator creates an instance of group activity.

In step 304, the presentation creator sets up the number of groups and set other parameters defining the behavior of that instance of activity.

In step 306, the presentation creator decides if the activity instance is being rendered in the way you want it to be. If yes, move to step 308 else go back to step 304 and set it up by changing parameters.

In step 308, the presenter plays the group activity instance in activity player.

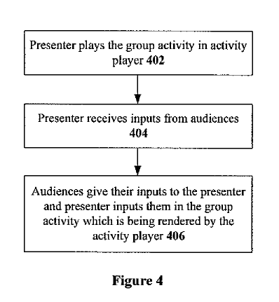

A preferred method for rendering group activity instance 114 will now be described with the help of flowchart in FIG. 4. This method may be used by a user as a ‘presenter’ who wants to render a group activity to the attendees/audiences.

In step 402, the presenter plays the group activity in the activity player.

In step 404, the presenter receives inputs from the audiences.

In Step 406, audiences give their inputs to the presenter and presenter inputs them in the group activity which is being rendered by the activity player.

Thus, the activity player helps in rendering instances of the group activity so that the users/presenters can display or present their sessions to the audiences in a much more interactive manner with audiences giving their inputs which the presenters can enter back into the group activity.

The above description of the invention has been described for purposes of clarity and understanding and not to limit the invention. It is understood that various modifications may be possible within the scope of the appended claims.

1. A system for creating and facilitating computer-based interactions amongst a group of individuals during a group activity, the system comprising:
an activity player for rendering instances of the group activity;
a library of activity templates;
an activity executable that is created by using instances of said activity templates;
an activity data file for storing data corresponding to the instances of activity templates used in the activity executable;
wherein said activity executable and activity data file is used to create the group activity to be rendered by the activity player.

2. The system as in claim 1, wherein an activity manager is provided for creating and/or modifying group activity instances by editing activity data file.

3. The system as in claim 1, wherein the activity executable is created by using instances of said activity templates in computer-based interaction code.

4 A method for creating and facilitating computer-based interactions amongst a group of individuals during a group activity, the method comprising steps of:
providing an activity player for rendering instances of the group activity;
providing a library of activity templates;
creating an activity executable by using instances of said activity templates;
creating an activity data file for storing data corresponding to the instances of activity templates used in the activity executable;
wherein said activity executable and activity data file are used to create the group activity to be rendered by the activity player.

5. The method as in claim 4, wherein an activity manager is provided for creating and modifying group activity instances by editing activity data file.

6. The method as in claim 4, wherein the activity executable is created by using instances of said activity templates in computer-based interaction code.

7. A computer program product embodied on a computer readable medium for creating and facilitating computer-based interactions amongst a group of individuals during a group activity, the computer program product comprising computer instructions for:
providing an activity player for rendering instances of the group activity;
providing a library of activity templates;
creating an activity executable by using instances of said activity templates;
creating an activity data file for storing data corresponding to the instances of activity templates used in the activity executable;
wherein said activity executable and activity data file are used to create the group activity to be rendered by the activity player.
